(19) United States
(12) Patent Application Publication
(10) Pub. No.: US 2024/0229831 A1
(43) Pub. Date: Jul. 11, 2024

(54) METHOD FOR THE AUTOMATED, MEASUREMENT DATA-BASED CONFIGURATION OF AN ELECTRONIC CONTROLLER FOR A HYDRAULIC SYSTEM

(71) Applicant: HAWE Hydraulik SE, Aschheim (DE)

(72) Inventor: Fabian KREUTMAYR, Aschheim (DE)

(21) Appl. No.: 18/406,437

(22) Filed: Jan. 8, 2024

(30) Foreign Application Priority Data
Jan. 11, 2023 (DE) 10 2023 200 194.2

(51) Int. Cl. F15B 15/20; F15B 19/00; G05B 19/042

(52) U.S. Cl. CPC F15B 15/20; F15B 19/007; G05B 19/0426; F15B 2211/63

(57) ABSTRACT

In a method for the automated, measurement data-based configuration of an electronic controller for a hydraulic system, a predefined measurement routine is performed on the hydraulic system, during which measurement data of measurement parameters of the hydraulic system are automatically acquired. This measurement data is used to train a computer-based model structure, i.e. to automatically identify the behavior of the hydraulic system. On the basis of system equations automatically extracted from the computer-based model structure, an electronic controller is automatically synthesized and then automatically embedded in a control unit of the hydraulic system in order to control at least one control variable, such as a pressure, a volume flow, a position or a displacement, in the hydraulic system. The automated steps of the method can be performed by an external device, which is connected to the hydraulic system via a data communication interface.

### CROSS REFERENCE TO RELATED APPLICATION

This application claims priority from German Patent Application No. 10 2023 200 184.2, filed on Jan. 11, 2023, the entire content of which is incorporated herein by reference in their entirety.

### FIELD OF THE INVENTION

The present invention relates to a method for the automated, measurement data-based configuration of an electronic controller for a hydraulic system, a device for the automated, measurement data-based configuration of an electronic controller for a hydraulic system, a method for controlling at least one control variable in a hydraulic system and a hydraulic system.

### BACKGROUND OF THE INVENTION

Hydraulic systems are used in a wide variety of technical fields and comprise at least one hydraulic consumer which is supplied with pressurized hydraulic fluid from a pressure source, for example a pump element or an accumulator, in order to perform work. Such a hydraulic consumer is regularly controlled via one or more valves in order to regulate the fluid flow directed to the hydraulic consumer and/or the fluid flow flowing from the hydraulic consumer to a reservoir.

Hydraulic consumers typically used are translatory or rotary hydraulic consumers. Depending on the complexity of the hydraulic system or the accuracy requirements of the hydraulic system, it may be necessary or desirable to control one or more control variables in the hydraulic system during operation of the hydraulic system. The parameters of the hydraulic system such as pressures, volume flows, paths, positions or temperatures are classically considered as control variables. The displacements and positions can be, for example, displacements and positions of a valve element, such as a valve piston, or axial or radial displacements and (angular) positions of a translational or rotational hydraulic consumer, such as a piston rod of a hydraulic cylinder.

Both mechanical controllers and electronic controllers are known in the state of the art as controllers for hydraulic systems, whereby PID controllers are most commonly used as electronic controllers. Both mechanical and electronic controllers are associated with problems in practice. Mechanical controllers, for example, suffer from wear-related problems, are not very flexible, are subject to inaccuracies due to series variations and are susceptible to vibrations. In addition, mechanical controllers cannot be individually adapted to an overall system. Electronic controllers, such as PID controllers, for example, suffer from the fact that their configuration and thus the control quality is heavily dependent on the person making the settings and the conditions actually prevailing in the hydraulic system, they are generally only really efficient at a few operating points and it is not possible to adapt the controller to changing conditions.

In addition, further problems often arise in practice when configuring controllers. For example, predefined mathematical or simulative models of the hydraulic system to be controlled are generally inaccurate due to incomplete information or information that is difficult to determine. In addition, for cost reasons, it can often be assumed that there are only a few sensors in the hydraulic system to be controlled, which makes precise control of the hydraulic system more difficult due to incomplete measurement data. The available capabilities of an electronic control unit of the hydraulic system to be controlled, such as computing power or memory space, are also often a limiting factor, especially in mobile hydraulic systems. Non-linearities that are characteristic of hydraulic systems, such as those caused by hysteresis or friction effects, also frequently impair the controller configuration.

### SUMMARY OF THE INVENTION

Accordingly, one objective of the present invention is to provide an electronic controller for a hydraulic system which has an improved control quality compared to the known controllers, for example to increase the throughput, the performance or also the energy efficiency of the hydraulic system, and which is able to adapt to non-linearities and dynamics prevailing in the hydraulic system to be controlled and to a large number of different operating points.

The solution to the problem is initially achieved with a method for the automated, measurement data-based configuration of an electronic controller for a hydraulic system according to embodiments of the present invention. Preferable embodiments are described in the dependent claims.

The method according to the invention for the automated, measurement data-based configuration of an electronic controller for a hydraulic system comprises the following steps: defining measurement parameters of the hydraulic system, executing a predefined measurement routine on the hydraulic system, automatically acquiring measurement data, preferably time series data, of the measurement parameters of the hydraulic system during the predefined measurement routine, automatically identifying a behavior of the hydraulic system on the basis of the acquired measurement data using at least one computer-based model structure, automatically extracting system equations of the hydraulic system from the at least one computer-based model structure, automatically synthesizing of the electronic controller on the basis of the extracted system equations, and automatically embedding of the synthesized electronic controller in an electronic control unit of the hydraulic system for controlling at least one control variable in the hydraulic system.

The method according to the invention makes it possible to automatically provide an electronic controller optimized for any hydraulic system for this specific hydraulic system. For this purpose, the method according to the invention combines methods of machine learning and (non-linear) control engineering with hydraulic systems and can also be applied in particular to existing hydraulic systems. In addition, the method offers the advantage that it can be repeated at any time in order to adapt the at least one computer-based model structure and thus the synthesized electronic controller to changed boundary conditions, such as changed environmental conditions or signs of wear, using newly acquired measurement data. The method according to the invention is therefore a concept of hybrid learning, since the electronic controller, once synthesized, initially remains unchanged during the ongoing operation of the hydraulic system, but can always be updated afterwards by repeating the method according to the invention.

A predefined measurement routine is to be understood in particular as a signal curve that is applied to at least one actuator in the hydraulic system over a predetermined period of time. For example, a signal curve can be applied as an actuating current to at least one electrically actuated valve of the hydraulic system (actuator). In the present case, an electrically actuated valve is to be understood in particular as an electromagnetically actuated valve. However, another form of electrical actuation of such a valve is of course also conceivable, for example via one or more electrically actuated stepper motors. An actuating current of an electrically actuated valve is therefore here in particular an actuating current of an electromagnetically actuated valve or an actuating current of a stepper motor for actuating a valve. This actuating current curve must of course be adapted to the respective hydraulic system in order to take into account the boundary conditions and limit values of the respective hydraulic system, such as a maximum valve current, a maximum deflection of a consumer or similar. Such an actuating current curve can take the form of a sweep, for example. Alternatively, the actuating current curve can also be used to jump to different (random) switching positions of an electrically actuated valve. In addition or alternatively, other boundary conditions can of course also be changed as part of the specified measurement routine, such as an external load on the hydraulic system.

In particular, the synthesized electronic controller is an algorithm, a formula or a lookup table. Depending on the application, an optimized electronic controller can be provided for the hydraulic system to be controlled.

For example, if the computing capacity of the electronic control unit of the hydraulic system to be controlled is particularly low, the synthesized electronic controller is implemented as a formula or lookup table. In this case, the usual operating points of the hydraulic system to be controlled are scanned during the execution of the specified measurement routine and the ideal controller parameters are approximated during the automated synthesizing of the electronic controller.

If sufficient computing capacity of the electronic control unit of the hydraulic system to be controlled is available, the synthesized electronic controller is an algorithm that is evaluated during operation by the electronic control unit for changing operating points. This enables more precise results to be achieved and thus a higher control quality.

In particular, the automated identification of the behavior of the hydraulic system preferably comprises an automated identification of the behavior of each hydraulic consumer of the hydraulic system based on the acquired measurement data using a computer-based model structure. In other words, a computer-based model structure is identified for each hydraulic consumer of the hydraulic system. In this way, the synthesized electronic controller is specifically configured and optimized for each existing hydraulic consumer. Of course, this is only possible if appropriate sensors are available to record the relevant measurement data in the hydraulic system to be controlled.

Preferably, the step of execution of the specified measurement routine is automated. The fact that the specified measurement routine is also carried out automatically means that an even higher degree of automation and error minimization is achieved.

Preferably, the computer-based model structure comprises at least one artificial neural network for function approximation. This allows the system behavior of the hydraulic system to be controlled to be identified particularly efficiently using the acquired measurement data. Alternatively or additionally, the computer-based model structure can comprise polynomials for function approximation.

Preferably, the computer-based model structure comprises an ANARX structure (additive nonlinear autoregressive exogenous model), an LSTM structure (long short-term memory), an ARMA structure (autoregressive-moving-average) and/or an RNN structure (recurrent neural network). Using these generally known computer-based model structures, preferably using an ANARX structure, the acquired measurement data can be automatically converted into a model for predicting the system behavior of the hydraulic system to be controlled. The ANARX structure in particular offers the advantage that it can be easily reformulated into system equations. However, this is also possible in principle for all other computer-based model structures mentioned.

Preferably, the synthesized electronic controller is a robust controller. With a robust controller, deviations in the behavior of the hydraulic system during operation from the behavior identified by the measurement routine can be compensated for particularly well. Preferably, the robust controller is a controller of type H-infinite, a controller of type H2, a controller of type backstepping or a controller of type model predictive control.

Preferably, the measurement parameters comprise at least one hydraulic parameter of the hydraulic system and at least one actuating current of an electrically actuated valve, in particular an electromagnetically actuated valve or a valve actuated by means of a stepper motor, and the step of automated acquisition of measurement data comprises: automated acquisition of measurement data of at least one hydraulic sensor of the hydraulic system and automated acquisition of measurement data of at least one actuating current of an electrically actuated valve of the hydraulic system. In particular, a manipulated variable of the synthesized electronic controller comprises the at least one actuating current of an electrically actuated valve. In particular, the hydraulic system comprises in each case at least one electrically actuated valve for actuating a hydraulic consumer and the automated acquisition of measurement data comprises the automated acquisition of all actuation currents of electrically actuated valves of the hydraulic system that are used to actuate the hydraulic consumer.

Preferably, the at least one hydraulic parameter is a pressure and/or a volume flow and the at least one hydraulic sensor is a pressure sensor and/or a volume flow sensor. Alternatively or additionally, the at least one hydraulic parameter can also be a derived value, for example a volume flow derived from the measured travel speed of an electrically actuated valve. In this way, the synthesized electronic controller can be optimized depending on the existing sensors in the hydraulic system to be controlled and the desired control variable.

Preferably, the measurement parameters comprise at least one displacement and/or position, in particular of a valve element and/or a hydraulic consumer, and the step of automated acquisition of measurement data comprises automated acquisition of measurement data from the at least one displacement sensor and/or position sensor. If the control variable to be controlled comprises a displacement and/or a position of a valve element and/or a hydraulic consumer, it is necessary to acquire the actual values of this control variable via a corresponding displacement and/or position sensor both for the configuration of the electronic controller and during the operation of the hydraulic system using the synthesized electronic controller.

Preferably, the measurement parameters include all parameters available for measurement in the hydraulic system. In particular, this includes all parameters recorded by hydraulic sensors in the hydraulic system, all actuation currents of electrically actuated valves in the hydraulic system and all acquired displacement and/or position parameters of any available displacement and/or position sensors. The accuracy of the synthesized controller can be maximized by incorporating all available measurement parameters of the hydraulic system to be controlled. In principle, it is also conceivable not to include all the metrologically available parameters of the hydraulic system to be controlled. This can be useful, for example, if a specific, clearly defined control task is to be solved, for the fulfillment of which not all metrologically available parameters are required, or if the available capabilities of the electronic control unit of the hydraulic system are particularly limited.

Preferably, the automated steps of the process are carried out by an external device that is connected to the hydraulic system for this purpose via an electronic data communication interface. This allows the computationally intensive steps of the process to be outsourced and only the actual control during operation to be performed by the hydraulic system's electronic control unit, which is limited in its capabilities.

Alternatively, the automated steps of the process can be carried out by the electronic control unit of the hydraulic system. This is possible if the capabilities of the electronic control unit of the hydraulic system are sufficient to carry out the computationally intensive automated steps.

It may be preferable if the execution of specified measurement routine and the acquisition of the measurement data are performed virtually using a simulation model of the hydraulic system. In this way, it can be ensured, especially in the case of particularly safety-critical hydraulic systems, that the execution of the specified measurement routine does not lead to critical situations, such as uncontrolled movements of a boom, in which, in the worst case, the respective machine is damaged or even users are endangered. In such a case, the method according to the invention is preferably repeated and a reduced specified measurement routine is carried out on the real hydraulic system during the repetition in order to adjust the electronic controller synthesized by using the simulation model to the real hydraulic system.

Furthermore, the solution to the problem is achieved with a device for the automated, measurement data-based configuration of an electronic controller for a hydraulic system according to claim 14.

The device according to the invention for the automated, measurement data-based configuration of an electronic controller for a hydraulic system comprises an electronic data communication interface for establishing a two-way data connection with the hydraulic system and an electronic computing unit. The electronic computing unit is configured to perform the automated steps of the method according to the invention for the automated, measurement data-based configuration of an electronic controller for a hydraulic system. In particular, the data communication interface is a wireless or wired, in particular a serial, communication interface.

The device according to the invention for the automated, measurement data-based configuration of an electronic controller for a hydraulic system allows the computationally intensive steps of the method according to the invention for the automated, measurement data-based configuration of an electronic controller for a hydraulic system to be outsourced from the electronic control unit of the hydraulic system to the electronic computing unit of the device. Preferably, the device comprises the hydraulic system.

Furthermore, the problem can be solved with a method for controlling at least one control variable in a hydraulic system according to an embodiment of the present invention.

The method according to the invention for controlling at least one control variable in a hydraulic system comprises an automated, measurement data-based configuration of an electronic controller for the hydraulic system with the method described above for the automated, measurement data-based configuration of an electronic controller for a hydraulic system and a control of the at least one control variable in the hydraulic system by the synthesized electronic controller.

Using the method according to the invention for controlling at least one control variable in a hydraulic system, the synthesized controller, which is optimized with regard to its control quality, is able to adapt to the non-linearities and dynamics prevailing in the hydraulic system and to a large number of different operating points.

Preferably, the at least one control variable comprises a pressure, a volume flow, a displacement and/or a position. These control variables represent classic parameters to be controlled in a hydraulic system.

Finally, the solution to the problem is achieved with a hydraulic system according to an embodiment of the invention.

The hydraulic system according to the invention comprises at least one hydraulic consumer, at least one electrically actuated valve, in particular an electromagnetically actuated valve or a valve actuated by means of a stepper motor, for actuating the at least one hydraulic consumer, at least one hydraulic sensor and an electronic control unit. The electronic control unit is configured to perform the automated steps of the method according to the invention for controlling at least one control variable in a hydraulic system.

The at least one hydraulic consumer is, in particular, a translatory or a rotatory hydraulic consumer. For example, a 2/2 proportional directional control valve, a 3/3 proportional directional control valve, a 4/3 proportional directional control valve or a 3/2 proportional directional control valve can be used as an electrically actuated valve. Corresponding switching valves or seat valves can also be used. A switching valve is defined here as a black and white or binary valve that only has the “open” and “closed” positions.

By using at least one electrically actuated valve, the actuating current of the at least one electrically actuated valve can be used as the manipulated variable of the synthesized controller, in particular the actuating current of an electromagnetically actuated valve or the actuating current of a valve actuated by a stepper motor. Accordingly, electrically actuated valves frequently used in modern hydraulic systems can be used as actuators in the control loop.

Preferably, each hydraulic consumer of the hydraulic system is controlled via at least one electrically actuated valve of the hydraulic system. As a result, one or more control variables for each hydraulic consumer of the hydraulic system can be controlled by the synthesized controller. Preferably, during the method according to the invention for the automated, measurement data-based configuration of the electronic controller for the hydraulic system, a computer-based model structure is identified for each hydraulic consumer of the hydraulic system. In this way, the synthesized electronic controller is specifically configured and optimized for each existing hydraulic consumer.

Preferably, at least one hydraulic sensor is assigned to each electrically actuated valve of the hydraulic system. This allows the relevant hydraulic parameters of the hydraulic system, such as pressures or volume flows, to be acquired in the direct vicinity of the electrically actuated valve (control variable) and used for the synthesis of the electronic controller and for controlling the at least one control variable. Preferably, for each electrically actuated valve, a pressure upstream and a pressure downstream of the electrically actuated valve is recorded by hydraulic sensors configured as pressure sensors, viewed in the direction of flow to the hydraulic consumer.

### BRIEF DESCRIPTION OF THE DRAWINGS

FIG. 1 is a hydraulic system according to the invention according to a first embodiment;

FIG. 2 is a hydraulic system according to the invention according to a second embodiment;

FIG. 3 is a simplified block diagram of the methods according to the invention; and

FIG. 4 is a simplified example of a computer-based model structure in the form of an ANARX structure.

### DETAILED DRAWINGS OF THE INVENTION

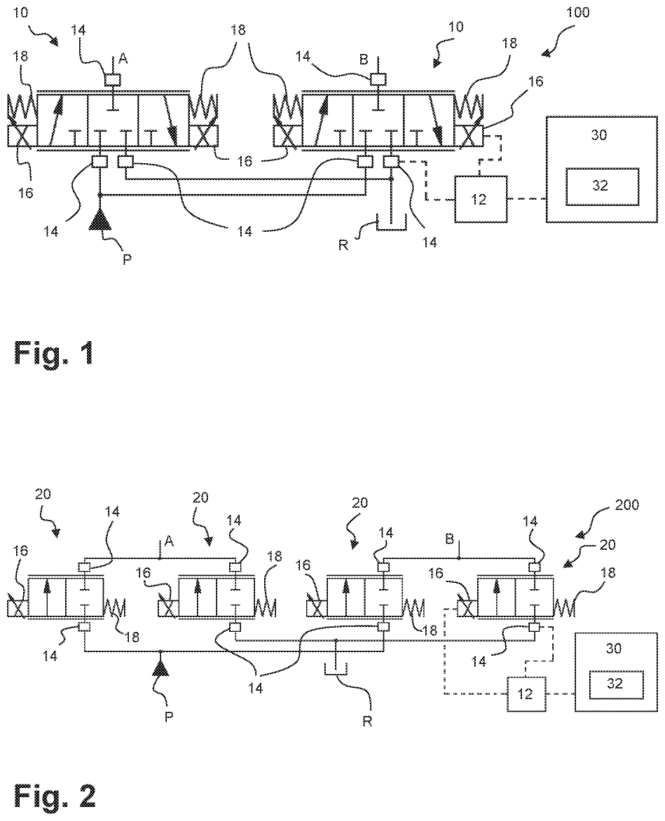

An example of a hydraulic system 100 according to the invention according to a first embodiment is shown in FIG. 1. The hydraulic system 100 comprises two first electrically actuated valves 10, a hydraulic consumer connection A and a hydraulic consumer connection B, a pressure source P, a hydraulic reservoir R, an electronic control unit 12 and six hydraulic sensors 14. The hydraulic system 100 also comprises a hydraulic consumer, the inlet and outlet of which are connected to the hydraulic consumer connections A and B. The hydraulic consumer is not shown in detail in FIG. 1, but can be a translatory or rotatory hydraulic consumer in a known manner. In principle, of course, it is also conceivable that only one inlet or outlet of different hydraulic consumers is connected to each hydraulic consumer connection A, B.

In this embodiment, the first electrically actuated valves 10 are configured as electromagnetically actuated 3/3 proportional directional control valves, each of which is provided for actuating one of the hydraulic consumer connections A and B. For this purpose, each of the first electrically actuated valves 10 is hydraulically connected to the pressure source P, to the hydraulic reservoir R and to one of the hydraulic consumer connections A and B. By continuously or proportionally shifting a valve piston in the first electrically actuated valve 10, the hydraulic consumer connection A or B can be supplied with pressurized hydraulic fluid from the pressure source P or relieved towards the hydraulic reservoir R. The valve piston is moved by two electromagnetic actuators 16, the energization of which is controlled by the electronic control unit 12. The electromagnetic actuators 16 therefore act as actuators here. All electromagnetic actuators 16 are connected to the electronic control unit 12, even if this is only indicated by a dashed line for one electromagnetic actuator 16 as an example in FIG. 1. In the neutral center position of the first electrically actuated valve 10, all connections are blocked. Two return springs 18 bring the valve piston of the first electrically actuated valve 10 into the neutral center position when the electromagnetic actuators 16 are not energized.

In this exemplary embodiment, the hydraulic sensors 14 are configured as pressure sensors, which detect the pressures at the connections of each first electrically actuated valve 10 and transmit their measurement data to the electronic control unit 12. It is of course also conceivable that one or more of the hydraulic sensors 14 are configured as volume flow sensors. It is also conceivable that several hydraulic sensors 14 are assigned to a single connection of the first electrically actuated valve 10. Again, for clarity reasons, only the connection of a hydraulic sensor 14 to the electronic control unit 12 is shown in FIG. 1. However, it is obvious to the skilled person that all other hydraulic sensors 14 are also connected to the electronic control unit 12, for example via corresponding cables or also via radio, NFC or Bluetooth. In the present case, all pressures upstream and downstream of the first electrically actuated valves 10 are acquired by the hydraulic sensors 14, viewed in the direction of flow from the pressure source P to the respective hydraulic consumer connection A and B. Three hydraulic sensors 14 are therefore assigned to each first electrically actuated valve 10 of the hydraulic system 100. However, it is of course also conceivable, for example, not to provide any hydraulic sensors 14 in the outlets to the hydraulic reservoir R.

As also shown in FIG. 1, the hydraulic system 100 is connected to an external device 30, which comprises a data communication interface for establishing a two-way data connection with the hydraulic system 100 and an electronic computing unit 32. More specifically, the electronic control unit 12 of the hydraulic system 100 is connected to the data communication interface of the external device 30 via its own data communication interface, which is shown as a dashed line in FIG. 1. The data communication interfaces can enable wireless or wired data communication between the electronic control unit 12 and the external device 30. For example, a WLAN connection or serial interfaces can be used as data communication interfaces. The external device 30 can comprise, for example, a laptop, a tablet, a smartphone, an industrial PC or even a cloud server.

FIG. 2 shows a hydraulic system 200 according to a second embodiment. The hydraulic system 200 differs from the hydraulic system 100 according to the first embodiment only in that it comprises four second electrically actuated valves 20 instead of the two first electrically actuated valves 10. In the hydraulic system 200, the hydraulic consumer connections A and B are therefore each controlled by two second electrically actuated valves 20. In this embodiment, the second electrically actuated valves 20 are configured as electromagnetically actuated 2/2 proportional directional control valves. A valve piston of the second electrically actuated valve 20 can therefore be switched continuously between a blocking position and an open position by the electromagnetic actuator 16. The return spring 18 of the second electrically actuated valve 20 positions the valve piston in such a way that the second electrically actuated valve 20 is in the blocking position when the electromagnetic actuator 16 is not energized.

As can be seen in FIG. 2, the hydraulic system 200 also comprises hydraulic sensors 14 in each inlet and outlet line to each of the four second electrically actuated valves 20. In this example, two hydraulic sensors 14 are therefore assigned to each second electrically actuated valve 20 of the hydraulic system. In the hydraulic system 200, the hydraulic sensors 14 are also configured as pressure sensors. However, it is of course also conceivable that one or more of the hydraulic sensors 14 of the hydraulic system 200 are configured as volume flow sensors. It is also conceivable that several hydraulic sensors 14 are assigned to a single connection of the second electrically actuated valve 20.

It is obvious to the skilled person that the hydraulic systems 100 and 200 described are merely examples. For example, only one hydraulic consumer connection A, B may be present in each case or also more than two hydraulic consumer connections A, B. In the hydraulic system 100, the hydraulic consumer connections A, B are each controlled by a first electrically actuated valve 10 and in the hydraulic system 200, the hydraulic consumer connections A, B are each controlled by two second electrically actuated valves 20. However, it is also conceivable that only one electrically actuated valve is provided, which controls two hydraulic consumer connections A, B. If a hydraulic consumer is therefore connected to the two consumer connections A, B, this can be controlled by one, two or four electrically actuated valves. In addition, any other combination of electrically actuated valves for controlling a hydraulic consumer is of course also conceivable, so that a consumer can also be controlled via three, five or more valves.

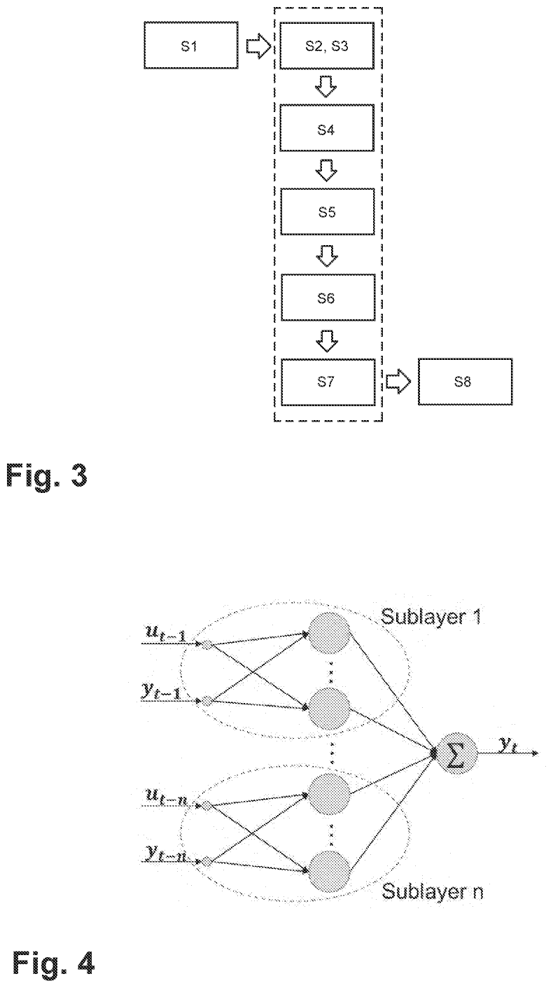

With reference to FIGS. 3 and 4, the methods according to the invention are now described.

The method according to the invention for the automated, measurement data-based configuration of an electronic controller for the hydraulic system 100, 200 comprises the following steps: defining measurement parameters of the hydraulic system (step S1 in FIG. 3), performing a specified measurement routine on the hydraulic system 100, 200 (step S2), automated acquisition of measurement data, in particular time series data, of the measurement parameters of the hydraulic system 100, 200 during the specified measurement routine (step S3), automated identification of the behavior of the hydraulic system 100, 200 on the basis of the acquired measurement data using at least one computer-based model structure (step S4), automated extraction of system equations of the hydraulic system 100, 200 from the at least one computer-based model structure (step S5), automated synthesizing of the electronic controller on the basis of the extracted system equations (step S6), and automated embedding of the synthesized electronic controller in the electronic control unit 12 of the hydraulic system 100, 200 for controlling at least one control variable in the hydraulic system 100, 200 (step S7). Steps S2 and S3 take place simultaneously and are also performed automatically in the present case. It is clear to the skilled person that the execution of the measurement routine does not necessarily have to be automated.

Defining the measurement parameters of the hydraulic system 100, 200 involves defining the parameters that are used in the configuration of the electronic controller and, subsequently, in the control of at least one control variable in the hydraulic system 100, 200. With reference to the hydraulic system 100, the measurement parameters are the acquired pressures of the six hydraulic sensors 14, which are configured as pressure sensors, and the actuating currents of the two first electrically actuated valves 10. With reference to the hydraulic system 200, the measurement parameters are the acquired pressures of the eight hydraulic sensors 14, which are configured as pressure sensors, and the actuating currents of the four second electrically actuated valves 20.

In this case, the consumer of the hydraulic system 100, 200 connected to the hydraulic consumer connections A and B is a hydraulic cylinder. As a measuring routine, the hydraulic cylinder is retracted and extended over a specified period of time. For this purpose, actuating currents are applied to the electrically actuated valves 10, 20 in the form of a sweep. For example, a sweep is generated for the extension of the hydraulic cylinder in such a way that the flow directions from the pressure source P to the hydraulic consumer connection A and from the hydraulic consumer connection B to the hydraulic reservoir R are always established. For the retraction of the hydraulic cylinder, the sweep is generated in such a way that the flow directions from the pressure source P to the hydraulic consumer connection B and from the hydraulic consumer connection A to the hydraulic reservoir R are always established. The constantly changing amplitude of the actuating currents of the electrically actuated valves 10, 20 due to the sweep generates a constantly changing flow rate, which changes the retraction or extension speed of the hydraulic cylinder. After each complete cycle (one retraction, one extension), the frequency of the sweep is changed, e.g. increased. Both the start frequency and the end frequency as well as the number of sweep cycles depend on the specific configuration of the hydraulic system 100, 200. The load on the hydraulic system 100, 200 can of course also be changed as part of the specified measurement routine. For example, an external load acting on the hydraulic cylinder can be applied, changed or removed. In principle, this description of a predetermined measuring routine is only an example and it is obvious to the skilled person that the predetermined measuring routine must be aligned with the specific hydraulic system. The boundary conditions of the corresponding system, such as a maximum valve current or a maximum deflection of a consumer, are included in the configuration of the respective measuring routine.

During the execution of the specified measurement routine on the hydraulic system 100, 200, the measurement parameters of the hydraulic system 100, 200 are acquired as time series data. This means that a measured value is available for each measurement parameter at discrete points in time. This is shown as an example in FIG. 4, in which a computer-based model structure, in this case an ANARX structure, is shown with two measurement parameters for time points t-1 to t-n, by means of which the behavior of the hydraulic system 100, 200 is automatically identified. In this case, the two measurement parameters are an input variable u, for example the current flow of an electrically actuated valve 10 or 20, and a control variable y, for example a detected pressure of a hydraulic sensor 14 configured as a pressure sensor. The time series data of the measurement parameters at the points in time t-1 to t-n are linked with each other in sublayers 1 to n of the artificial neural network of the ANARX structure in a weighted manner and then added up in order to be able to make a prediction about the control variable y at time t.

If a position or a displacement, for example of a valve element of the electrically actuated valves 10, 20 or of a consumer connected to the hydraulic consumer connections A, B, is to be controlled in the hydraulic system 100, 200, a corresponding position or displacement sensor must be provided in the hydraulic system 100, 200. The measurement data recorded by this position or displacement sensor are then also defined in step S1 as measurement parameters of the hydraulic system 100, 200.

It is clear to the person skilled in the art that not all parameters of the hydraulic system 100, 200 that are available in terms of measurement technology must be included as measurement parameters in the method according to the invention. However, it is desirable to use as many measurement parameters as possible for the automated, measurement data-based configuration of the electronic controller in order to achieve the highest possible control quality of the synthesized electronic controller.

For the hydraulic systems 100, 200 described above, the behavior of the hydraulic consumer connected to the two hydraulic consumer connections A and B is automatically identified in step S4 using a computer-based model structure. In general, for each hydraulic consumer in a hydraulic system to be controlled, the behavior of this hydraulic consumer is automatically identified using a separate computer-based model structure. For example, if there are two hydraulic consumers in such a hydraulic system, their behavior will also be automatically identified using two computer-based model structures. The automated identification of the behavior of the hydraulic system 100, 200 can also be referred to as training the computer-based model structure.

In step S5, system equations of the hydraulic system 100, 200 are automatically extracted from the computer-based model structure. In the present case, for example, a state space model is extracted from the computer-based model structure. In particular, this state space model can be a non-linear state space model.

In step S6, the electronic controller is automatically synthesized on the basis of the extracted system equations. For example, a linear parameter-varying (LPV) system is generated from the non-linear state space model. Jacobian matrices can also be generated from the state space model. In this case, the synthesized controller is a controller of type H-infinity. Alternatively, other types of controllers, such as H2, backstepping or model predictive control, can of course also be used.

In step S7, the synthesized electronic controller is automatically embedded in the electronic control unit 12 of the hydraulic system 100, 200. This means that the electronic controller, once synthesized, is no longer changed during the ongoing operation of the hydraulic system 100, 200. However, it is of course possible to repeat the method according to the invention for the automated, measurement data-based configuration of the electronic controller for the hydraulic system 100, 200 in order to adapt the synthesized electronic controller to changed environmental conditions.

As indicated by the dashed line in FIG. 3, the automated steps S2 to S7 of the method according to the invention are performed by the external device 30 in the present case. For this purpose, the external device 30 is connected to the hydraulic system 100, 200 via the data communication interface and the electronic computing unit 32 performs the automated steps S2 to S7.

It is of course also possible that the external device 30 is omitted and the automated steps S2 to S7 are carried out by the electronic control unit 12 of the hydraulic system 100, 200. This is particularly possible if the electronic control unit 12 has sufficient computing power and memory available to carry out steps S2 to S7. This is often not the case with existing mobile hydraulic systems in particular, which is why it makes sense in this case to outsource the computationally intensive steps S4 to S6 to the external device 30.

After the electronic controller has been synthesized and embedded in the electronic control unit 12, the method according to the invention for controlling at least one control variable in the hydraulic system 100, 200 is followed by controlling the at least one control variable in the hydraulic system 100, 200 by the synthesized electronic controller (step 8). As already mentioned, the at least one control variable in the hydraulic system 100, 200 can classically be pressures, volume flows, displacements or positions. The actuating currents of the electrically actuated valves 10, 20 act as control variables in the hydraulic system 100, 200.

With the methods according to the invention, the device 30 according to the invention and the hydraulic system 100, 200 according to the invention, electronic controllers can be configured and used in an automated and data-based manner. As a result, an individually adapted electronic controller can be automatically provided for each hydraulic system 100, 200 and for each conceivable control task for the respective hydraulic system 100, 200, which is optimally adapted to the actual conditions in the hydraulic system 100, 200. By outsourcing the computationally intensive process steps to the external device 30, the methods according to the invention can also be used in hydraulic systems in which only little computing power or memory space is available in the electronic control unit 12.

### REFERENCE NUMERALS

10 first electrically actuated valve
12 electronic control unit
14 hydraulic sensor
16 electromagnetic actuator
18 return spring
20 Second electrically actuated valve
100, 200 hydraulic system
A, B hydraulic consumer connection
P pressure source
R hydraulic reservoir
S1 to S8 process steps

1. A method for the automated, measurement data-based configuration of an electronic controller for a hydraulic system, the method comprising the following steps:
defining measurement parameters of the hydraulic system,
executing of a predefined measurement routine on the hydraulic system,
automatically acquiring measurement data of the measurement parameters of the hydraulic system during the predefined measurement routine,
automatically identifying a behavior of the hydraulic system on the basis of the acquired measurement data using a computer-based model structure,
automatically extracting system equations of the hydraulic system from the computer-based model structure,
automatically synthesizing the electronic controller based on the extracted system equations, and
automatically embedding the synthesized electronic controller in an electronic control unit of the hydraulic system for controlling at least one control variable in the hydraulic system.

2. The method according to claim 1, wherein executing of the predefined measurement routine is an automated execution.

3. The method according to claim 1, wherein the computer-based model structure comprises at least one artificial neural network for function approximation.

4. The method according to claim 3, wherein the computer-based model structure comprises an ANARX structure, an LSTM structure, an ARMA structure or an RNN structure.

5. The method according to claim 1, wherein the synthesized electronic controller is a robust controller.

6. The method according to claim 5, wherein the robust controller is a controller of type H-infinite, a controller of type H2, a controller of type Backstepping or a controller of type Model-Predictive-Control.

7. The method according to claim 1, wherein the measurement parameters comprise at least one hydraulic parameter of the hydraulic system and at least one actuating current of an electrically actuated valve and the step of automatically acquiring measurement data comprises:
automatically acquiring measurement data from at least one hydraulic sensor of the hydraulic system and
automatically acquiring measurement data of at least one actuating current of an electrically actuated valve of the hydraulic system.

8. The method according to claim 7, wherein the at least one hydraulic parameter is a pressure or a volume flow and the at least one hydraulic sensor is a pressure sensor or a volume flow sensor.

9. The method according to claim 7, wherein the measurement parameters comprise at least one displacement or position and the step of automatically acquiring measurement data comprises:
automated acquisition of measurement data from at least one displacement sensor or position sensor.

10. The method according to claim 1, wherein the measurement parameters include all parameters available for measurement in the hydraulic system.

11. The method according to claim 1, wherein the automated steps of the method are carried out by an external device which is connected to the hydraulic system for this purpose via an electronic data communication interface.

12. The method according to claim 1, wherein the automated steps of the process are performed by the electronic control unit of the hydraulic system.

13. The method according to claim 1, wherein the execution of predefined measurement routine and the acquisition of the measurement data are performed virtually using a simulation model of the hydraulic system.

14. A device for the automated, measurement data-based configuration of an electronic controller for a hydraulic system, the device comprising:
an electronic data communication interface for establishing a two-way data connection with the hydraulic system; and
an electronic computing unit configured to perform the automated steps of the method according to claim 1.

15. The device according to claim 14, the device further comprising the hydraulic system.

16. A method of controlling at least one control variable in a hydraulic system, the method comprising the following steps:
automated, measurement data-based configuring of an electronic controller for the hydraulic system using the method according to claim 1, and
controlling the at least one control variable in the hydraulic system by the synthesized electronic controller.

17. The method according to claim 16, wherein the at least one control variable comprises a pressure, a volume flow, a displacement or a position.

18. A hydraulic system, comprising:
at least one hydraulic consumer,
at least one electrically actuated valve for actuating the at least one hydraulic consumer;
at least one hydraulic sensor; and
an electronic control unit,
wherein the electronic control unit is configured to perform the automated steps of the method for controlling at least one control variable in the hydraulic system according to claim 16.

19. The hydraulic system according to claim 18, wherein each hydraulic consumer of the hydraulic system is controlled via at least one electrically actuated valve of the hydraulic system.

20. The hydraulic system according to claim 19, wherein the at least one hydraulic sensor is assigned to each electrically actuated valve of the hydraulic system.
